(19) United States
(12) Patent Application Publication
(10) Pub. No.: US 2008/0063002 A1
(43) Pub. Date: Mar. 13, 2008

(54) Multi-gateway system and methods for same

(75) Inventors: Hong Helena Zheng, Aliso Viejo, CA (US); Hui Lu, Beijing (CN); Jack Han-Chin Tai, San Gabriel, CA (US); Quang Chen, Xian (CN); Chungjun Jiang, Aliso Viejo, CA (US); Kan Lu, Irvine, CA (US)

Correspondence Address: Jenny Chen;7F, No. 1, Alley 30, Lane 358, Rueiguang Road, Neihu District, Taipei, 114, omitted

(73) Assignee: 3DSP Corporation

(21) Appl. No.: 11/900,158

(22) Filed: Sep. 11, 2007

Related U.S. Application Data
(60) Provisional application No. 60/843,297, filed on Sep. 11, 2006.

(51) Int. Cl. H04L 12/66; H04Q 7/24

(52) U.S. Cl. 370/401; 370/338

(57) ABSTRACT

A multi-gateway system is disclosed. The multi-gate system may include an access point associated with a zone, the access point providing a network coverage within the zone; a wireless client adapted to communicate with the access point when the wireless client is in the zone; and a virtual central processing device associated with a virtual media access control (MAC) address, wherein the virtual central processing device communicates with the access point to redirect a data packet between the wireless client and a destination.

### CROSS-REFERENCE TO RELATED APPLICATIONS

This application is related to and claims priority to U.S. provisional patent application, U.S. Provisional Application No. 60/843,297, filed on Sep. 11, 2006, by the applicants Hong Helena Zheng et al., entitled “Multi-Gateway System And Methods For Same.”

### FIELD OF THE INVENTION

The present invention relates to a multi-gateway system and methods for the same; particularly, the present invention relates to a multi-gateway system and methods for the same where electronic devices, or wireless clients, in a wired and wireless hybrid mesh network may seamlessly roam between different wired access points wirelessly.

### BACKGROUND OF THE INVENTION

Today's wireless network systems utilize single-hop or peer-to-peer hopping implementations to cover their network areas. A typical single-hop system includes a notebook computer utilizing WiFi communication protocols to wirelessly connect to a wired connection. Another example is a typical GSM mobile phone which requires physical structures such as base stations in order for the GSM mobile phone to operate within the area covered by the base stations (coverage area).

Although a peer-to-peer wireless hopping network is able to cover a larger area compared to a single hop wireless network, both single-hop and peer-to-peer hopping implementations still require wireless devices to remain within a single coverage area. This requirement restricts the mobility of wireless devices. There is also no mechanism for seamless passing of information wirelessly between one wired network to the next.

Accordingly, there is a need to dramatically increase coverage area. There is also a need to be able to seamlessly handle the wireless roaming from one wired network connection to the next.

### SUMMARY OF THE INVENTION

In one object of the present invention, a multi-gateway system where electronic devices, or wireless clients, in a wired and wireless hybrid mesh network may seamlessly roam between different wired access points wirelessly is provided. In accordance with the present invention, a wired and wireless hybrid network may be a mesh network that comprises wireless and wired routes between networked devices. Wireless clients may be a single device or a cluster of devices connected by wires or wirelessly.

In another object of the present invention, a data routing method where electronic devices, or wireless clients, in a wired and wireless hybrid mesh network may seamlessly roam between different wired access points wirelessly is provided.

In another object of the present invention, an electronic device implemented with a wireless client adapted to communicate in a multi-gateway system so as to seamlessly roam between different wired access points wirelessly is provided.

Other objects of the present invention can be readily ascertained by one of ordinary skilled in the arts upon review of the detailed descriptions of the preferred embodiments.

### BRIEF DESCRIPTION OF THE DRAWINGS

FIG. 1 a schematic diagram of a peer-to-peer wireless network in accordance with the present invention; and

FIG. 2 illustrates a flow chart of a data routing method in accordance with the present invention.

### DETAILED DESCRIPTION OF THE PREFERRED EMBODIMETNS

Reference will now be made in detail to the embodiments of the present invention. Examples of embodiments are illustrated in the accompanying drawings, wherein like reference numbers refer to like elements throughout the specification.

The present invention provides a system and method for electronic devices in a wired and wireless hybrid mesh network to seamlessly roam between different wired access points wirelessly. The electronic devices may be connected to the wired access point directly or through any wireless or wired hopping or routing mechanism. The system of the present invention may utilize a peer-to-peer hopping scheme to allow wireless electronic devices within a single gateway zone to stay connected. Preferably, the system of the present invention may utilize a peer-to-peer hopping scheme to allow wireless electronic devices to stay connected in a large wireless network area where wireless electronic devices need not remain within a single coverage area. Although the preferred embodiments of the present invention will be described in a wireless peer-to-peer implementation, those skilled in the art should understand that the present invention may also be utilized in any wired and wireless hybrid network so as to allow electronic devices to roam seamlessly between different wired access points wirelessly.

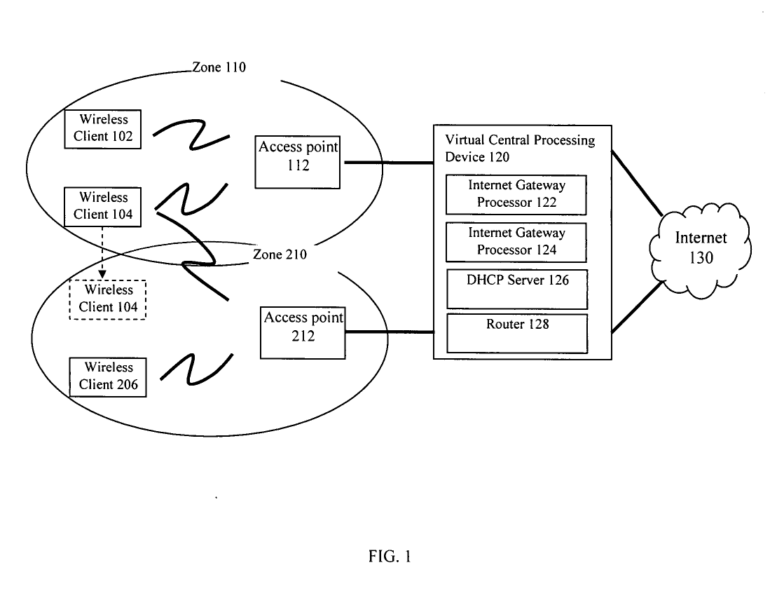

Refer to FIG. 1, which illustrates a schematic diagram of a peer-to-peer wireless network 100 in accordance with the present invention. As shown in FIG. 1, the peer-to-peer wireless network 100 may include a plurality of wireless clients 102, 104, 206, a plurality of access points 112, 212, and a virtual central processing device 120.

In accordance with the present invention, wireless clients 102, 104, 206 may reside in a respective electronic device, such as electronic devices 102a, 104a, 206a (not shown) so as to send a data packet destined to a web site on the Internet 130. Access points 112, 212 of the present invention may by implemented by hardware means or software means. In one embodiment, access points 112, 212 of the present invention is implemented by hardware means, such as physical micro gateways, acting as an interface between the wireless world, where for example wireless clients 102, 104, 206 reside, and the wired world, where for example a digital subscriber line (DSL) modem (not shown) resides. In a preferred embodiment, virtual central processing device 120 may be implemented by software means so as to redirect the data packet between a destination, such as a web site on the Internet 130, and wireless clients 102, 104, 206.

As shown in FIG. 1, each access point 112, 212 in peer-to-peer wireless network 100 may have a respective zone, such as zones 110, 210. In accordance with the present invention, a zone may contain all of the wireless clients that will receive down stream data from the access point. For example, zone 110 may contain wireless clients 102, 104 that receive down stream data from access point 112, while zone 210 may contain wireless client 206 that receives down stream data from access point 212.

However, in one preferred embodiment, a wireless client can send up stream data through any access point. For example, wireless client 104 can send up stream data through access point 102 or 212. Zones of the different access points in vicinity, such as zones 110, 210, may overlap to allow for mobility and fault tolerance, as shown in FIG. 1.

In accordance with the present invention, the size of zones 112, 212 may depend on the maximum allowed mobile speed and a probe period.

Zone diameter=Speed*probe period*2*mP

Wherein mP is the maximum allowed number of probes that can be missed and a probe period is the period/frequency when a probe/signal is sent to a wireless client, such as wireless client 104, to determine its presence.

In accordance with the present invention, each wireless client 102, 104, 206 may locate in a respective electronics device (not shown), as mentioned above, which may either be stationary or mobile in relation to an access point, such as access points 112, 212. Specifically, a stationary wireless client, such as wireless client 102, may remain within a single zone, such as zone 110, during the full duration of its existence, and thus access point 112 may always route a data packet sent by wireless client 102 to its destination and return a reply response from the destination back to wireless client 102. In such a case, stationary wireless client 102 may access the Internet 130 directly without going through virtual central processing gateway 120.

In one embodiment, the user may configure wireless client 102 as stationary through a command line or GUI. Once it is configured as a stationary wireless client, wireless client 102 will not be able to change the zone, such as zone 110, until a reconfiguration. If wireless client 102 were to move outside of zone 110, it will lose connection until a reconfiguration.

In an embodiment where a wireless client, such as wireless client 102, is configured as stationary, access point 112 may be the default gateway for the stationary wireless client rather than the virtual central processing device 120 to pass the last data packet. In other words, access point 112 may detect the data packet from/to stationary wireless client 102.

In one preferred embodiment, stationary wireless client 102 does not target any address in virtual central processing device 120, and thus may not do any tunneling function for the data packets going to/from stationary wireless client 102. All data transfer between stationary wireless client 102 and an Internet site, such as Google, may pass through access point 112, and sent to the Internet 130 directly. Table 1 shows an example packet from stationary wireless client 102 to an Internet site, such as Google.

TABLE 1
Example packet from the Stationary Wireless Client

| Destination | Google:80 |
|---|---|
| Source | 10.0.0.2 |

In the example where a stationary wireless client, such as wireless client 102, is to access an Internet site, such as Google, directly, the original data packet may simply have a destination targeted to Google, and a source originated from a local IP address of stationary wireless client 102 or a device connected thereto. Stationary wireless client 102 may then perform name address translation (NAT) to resolve the source in a way that the default access point, such as access point 112, may recognize so as to pick up the data transfer.

For example, wireless client 102 may resolve the source address of 192.168.0.2 to a local IP address of access point 112, such as the 10.x.x.x subnet. Once default access point 112 picks up the original data, access point 112 may once again perform name address translation to resolve the source address of 10.0.0.2 to a local IP address recognizable by an ADSL modem (not shown). The ADSL modem (not shown) may perform name address translation one more time to resolve the source to an IP address recognizable by a telecom network (not shown). Finally, wireless client 102 may now access the Internet 130. Table 2 shows the standard network access as mentioned above.

TABLE 2
Example network access for the Stationary Wireless Client
Original packet:

| Destination | Google:80 |
|---|---|
| Source | 192.168.0.2: 50 |

Wireless client may perform name address translation (NAT)

| | |
|---|---|
| Destination | Google:80 |
| Source | 10.0.0.2: 100 |

Default access point will perform NAT again

| | |
|---|---|
| Destination | Google:80 |
| Source | 192.168.0.2: 200 |

ADSL modem will perform NAT

| | |
|---|---|
| Destination | Google:80 |
| Source | 166.0.0.55: 400 |

When the Internet site, such as Google, wants to return a response back to the originator, such as wireless client 102, the returned response may be sent to 166.0.0.55: 400 and work its way in a reverse order back to wireless client 102.

Alternatively, in accordance with the present invention, the wireless client may also be a mobile wireless client, such as wireless client 104, which changes its zone from for example zone 110 to zone 210 during operation. In such a case, the access point associated with the zone in which the mobile wireless client is located may route the data packet to its destination for the mobile wireless client. For example, as shown in FIG. 1, when wireless client 104 is located within zone 110, access point 112 may route a data packet sent by wireless client 104 to its destination. Alternatively, when wireless client 104 is changed to zone 210, access point 212 may return a reply response back from its destination.

In accordance with the present invention, mobile wireless client 104 may periodically send out hello messages to virtual central processing device 120, so that virtual central processing device 120 will know which zone mobile wireless client 104 belongs to. In a preferred embodiment, the hello messages may be one-directional from wireless client 104 to access point 112. In one preferred embodiment, there is no return path generated by the hello messages. In one embodiment, access point 112 may not have the return path to the wireless client 104 until there is real data traffic.

In a preferred embodiment, two timeout values may be used for missing of the hello message. The first, a relative short time out, may be for re-association and a 2^{nd} timeout is for loss of IP address. Table 3 shows an example of timing parameters that may be implemented.

TABLE 3
Exemplary Timing parameters

| Parameter | Value |
|---|---|
| Gradient table time out | <6 sec |
| (Gtimeout + Otimeout) | |
| Hello message interval | 60 sec |
| Re-associate time out | 10 hello message interval |
| Loss IP address timeout | 100 hello message interval |

In accordance with the present invention, mobile wireless client 104 may repackage the data packet before it is sent to the access point, such as access point 112, whose associated zone mobile wireless client 104 belongs to. As shown in Table 4, an exemplary original data packet from the TCP level may include a source, which is the local address of mobile wireless client 104, and a destination, which is the IP address of an Internet site, such as Google. As a result, an encapsulated data packet may be sent through wireless and wired hybrid network. As compared to Table 5, mobile wireless client 104 may add an additional TCP header to the original data packet, indicating a destination, such as a local IP address of virtual central processing device 120, and a source, such as the local IP address of the mobile wireless client 104, as shown in Table 5.

TABLE 4
Exemplary original packet from the TCP layer

| Destination | Google:80 |
|---|---|
| Source | 10.0.0.2 |

TABLE 5
Exemplary packet after encapsulation by the wireless client

| Destination | Local IP of Virtual Central |
|---|---|
| | Processing Device |
| Source | 10.0.0.2 |

Mesh Header

| | |
|---|---|
| Destination | Google:80 |
| Source | 10.0.0.2 |

In one embodiment, when a wireless client 104 boots, wireless client 104 may first send a DHCP request to an access point, such as access point 112, requesting an IP address of wireless client 104. In one embodiment, access point 112 may act as a DHCP relay and obtain the IP address for the wireless client 104 from virtual central processing device 120. After obtaining the local IP address, wireless client 104 may now communicate directly with virtual central processing device 120 to obtain an IP address of a gateway processor, such as Internet gateway processor 122.

In a preferred embodiment, Internet gateway processor 122 may be a machine in virtual central processing device 120 to redirect the data packet for mobile wireless client 104. As a result, Internet gateway processor 122 may be the default gateway for wireless client 104. Once obtaining the local IP address of virtual central processing device 120, or preferably, Internet gateway processor 122, wireless client 104 may now communicate with virtual central processing device 120 as if they are in a single virtual network.

Since virtual central processing device 120 may have more than one gateway processor, such as Internet gateway processors 122, 124, as shown in FIG. 1, wireless client 104 may have different processor IP address from each other. In a preferred embodiment, only one MAC address is used to assist the wireless routing or hopping. The virtual MAC address may be mapped to multiple devices at various physical locations and IP addresses. As a result, an address resolution protocol (ARP) table associating a virtual media control access (MAC) address with Internet gateway processors 122, 124, may need to be artificially put in as below.

Local IP of Internet Gateway Processor: Virtual MAC Address

In one preferred embodiment, mobile wireless client 104 may also remember the IP address of an access point that the last received packet come through so as to facilitate data transfer.

Furthermore, in accordance the present invention, an additional header, such as a mesh header, information may be added in between the 2 TCP headers. This header may provide information to virtual central processing device 120 for packet re-sequencing purpose.

In accordance with the present invention, all data transfer between mobile wireless client 104 and an Internet site, such as Google, needs to pass through access point 112 and virtual central processing device 120 through tunneling. Preferably, an asymmetric tunneling scheme is implemented. In a preferred embodiment, when a data packet is sent by wireless client 104 and received by an Internet site, such as Google, the tunneling may begin at wireless client 104 and ends at virtual central processing device 120. On the other hand, when a data packet is sent by an Internet site, such as Google, and received by wireless client 104, the tunneling may begin at virtual central processing device 120 and end at access point 112. In case where mobile wireless client 104 has moved from one zone to another, such as from zone 110 to zone 210, tunneling may begin at virtual central processing device 120 and end at access point 212, accordingly.

In accordance with the present invention, wireless clients 102, 104, 206 may have a local dynamic host configuration protocol (DHCP) function to assign local IP addresses to devices connected to it through for example, an Ethernet cable. In other words, wireless clients 102, 104, 206 may serve as a gateway to the connected device to the wireless mesh domain.

As mentioned before, access points 112, 212 may be the connecting points between a wireless mesh network and a wired Internet entry point for example a DSL modem (not shown). Access points may route the data packets from/to the wireless clients to/from the virtual central processing device. For example, access point 112 may route the data packets from both stationary wireless client 102 and mobile wireless client 104 to virtual central processing device 120, and vice versa. Alternatively, access point 212 may route the data packets from wireless client 206 to virtual central processing device 120, and vice versa.

In a preferred embodiment, messages passing between access points, such as access points 112 and 212, do not require any roaming hand over. In another preferred embodiment, the wireless client, such as wireless client 104, may be able to simultaneously route packets through multiple access points, such as access points 112 and 212 to the Internet 130 when wireless client 104 locates at a point overlapped by both zones 110 and 210.

In accordance with the present invention, access points 112, 212 may continuously send probing packets, such as fast probing packets, using the virtual MAC address as the destination after access points 112, 212 have been associated therewith. The virtual MAC address may symbolize a virtual central processing device, such as virtual central processing device 120, but is not necessarily the physical MAC address of virtual central processing device 120.

Preferably, access point 112, for example, may establish a gradient table to the virtual MAC address of virtual central processing device 120 after power up. It is this gradient table to this virtual MAC address that establishes a connection status for the wireless clients, such as wireless client 104. Generally speaking, a connection status is a status that a wireless client, such as wireless client 104, obtains after it has established a valid route to the virtual central processing device, such as virtual central processing device 120.

In one embodiment, access point 112 sends out a fast probe packet every fast probe period as long as there are gradient entries in the gradient table. Each gradient entry may indicate a route to one destination address, i.e. the virtual MAC address.

In accordance with the present invention, an exemplary gradient entry may include but not limited to an entry for destination ID, which may be a MAC address of a destination, an entry for cost, which may be the best cost from the access point to the destination, an entry for cost ID, which may be a cost function used to calculate the best cost, an entry for best neighbor, which may be the best neighbor to go through to get to the destination, an entry for frozen status, which may indicate whether this gradient entry is frozen or not, an entry for frozen cost, which may indicate the cost from the access point to the destination at the time of freezing if the entry is frozen, an entry for frozen cost list, which may be all of the frozen cost, an entry for originator list, which may indicate the packet originators for this gradient entry, an entry for ready flag, which may be asserted if the route to destination is established, and an entry for ready time out, which may be initialized when the gradient entry is first created or when the ready flag is set.

In a preferred embodiment, when wireless client 104 is trying to send a packet to virtual central processing device 120, the virtual MAC address is used as the destination MAC address. Preferably, the software in access point 112 may recognize this virtual MAC address and send the packet to the TCP layer for further delivery. Additionally, all access points 112, 212 have a finite cost to the virtual MAC address. In one embodiment, this cost may be assigned by a router 128 to access point 112.

In accordance with the present invention, when a wireless client, such as wireless client 104, is trying to send a data packet to virtual central processing device 120, the virtual MAC address is used as the destination MAC address. Preferably, access points may be implemented with software that recognizes this virtual MAC address so as to send the packet to the TCP layer for further delivery. Preferably, only one virtual MAC address for the entire peer-to-peer wireless network 100 is used, even though there may be multiple MAC addresses for the different parts of virtual central processing device 120. For example, a router 128 within virtual central processing device 120 may have a physical MAC address of its own. However, a data packet destined to router 128 within virtual central processing device 120 would still have the virtual MAC address associated therewith, instead of the physical MAC address of router 128.

In accordance with the present invention, when a wireless client, such as wireless client 104, attempts to send a data packet to a wireless domain, such as zone 110, wireless client 104 may first try to create a table identifying the path to the associated access point, such as access point 112. The table may indicate the number of hops, or the number of wireless clients, needed to reach an access point.

In one embodiment, the wireless client, such as wireless client 104, in zone 110 may first try to maintain a minimum set of close neighbors, namely other wireless clients within the same zone 110 by increasing its transmit power until a predetermined number is met. For example, wireless client 104 located in zone 110 may have five close neighbors to help it reach access point 112. In another example where wireless client 104 moves from zone 110 to zone 210, wireless client 104 may now need to maintain a minimum set of close neighbors, such as wireless clients in zone 210, in order to reach access point 212. Once the minimum set of close neighbors is met, wireless client 104 may then determine which neighbor or neighbors are needed to reach access point 112. For example, wireless client 104 in zone 110 may need three hops in order to reach access point 112.

If the path to the destination cannot be found after a timeout, the destination may be deemed to be unreachable, and the data packet may be deleted. To avoid data congestion, once a destination is unreachable, wireless client 104 may not try to re-establish the connection for a certain amount of time. During this time, in a preferred embodiment, all packets to that destination may be deleted.

Preferably, all wireless clients 102, 104, 206 should have at least 1 close neighbor, namely another wireless client, with a connection status. Also preferably, all of the wireless clients 102, 104, 206 are no more than a maximum number of hops away from an access point, such as access point 112 or 212. One method of achieving this is by having the hop count with for example access point 112 as the originator be less than or equal to for example 10, i.e. 10 or less hops. However, even with a hop count to the access point, such as access point 112, of less than 10 hop count, a data packet could still take more than 10 hops to get to access point 112. Thus, preferably, the hop count limit in the data packet should be less than 10 to avoid data packets to be deleted accidentally.

In accordance with the present invention, the access point, such as access point 112, 212, may operate to redirect data traffic. An operating condition of an access point, such as access point 122 or 212, may be used to determine which access point a wireless client, such as wireless client 104, is to communicate with. The operating condition of the access points may include but not limited to loading of the hardware, channel condition in the air, number of wireless devices in its vicinity, and distance of each wireless device to the access point. In a preferred embodiment, the data flow from the wireless client, such as wireless client 104, to the Internet 130 may be directed through different access points based on the operating condition of the access points. In a preferred embodiment, the redirect decision may be done dynamically on a packet per packet basis. Specifically, the access point may inform a processor such as a digital signal processor (DSP) that the data packets destine to the virtual central processing device's MAC address may be sent to the host.

In accordance with the present invention, the access points, such as access points 112 and 212, may store the mapping of the local IP address of the virtual central processing device, such as virtual central processing device 120, to the global IP address of the virtual central processing device, such as virtual central processing device 120. Table 6 shows an example packet with the header information modified by access point 112. Specifically, as can be seen from Table 6, the local IP address of virtual central processing device 120 is modified to the global IP address of virtual central processing device 120 by access point 112, while the mesh header and the original data packet remain unchanged.

TABLE 6
Example packet after modification by the access point

| Destination | Global IP of Virtual Central |
|---|---|
| | Processing Device |
| Source | 10.0.0.2 |

Mesh Header

| | |
|---|---|
| Destination | Google:80 |
| Source | 10.0.0.2 |

In a preferred embodiment, after receiving a data packet from the DSL box, access point 112 may check the destination address. If a special port is assigned, access point 112 may strip off, or de-capsulate, the outer IP address and the mesh header, then send the data packet out to the air using, for example, wireless mesh routing algorithm.

Additionally, the access point of the present invention, such as access point 112 may aggregate the information from the hello messages sent by the wireless clients, such as wireless client 104, then send a periodic message to virtual central processing device 120.

In accordance with the present invention, a virtual central processing device such as virtual central processing device 120, may be used to redirect packets between the electronic devices (not shown) and the Internet 130. The virtual central processing device may be one or more devices in one or more physical locations with one or more addresses. The number of virtual central processing devices may increase or decrease based on the loading and complexity of the system.

In one preferred embodiment, one physical device, such as an Internet gateway processor 122 or 124, among the central processing devices may redirect packets for one or more wireless clients, such as wireless client 104. In a preferred embodiment, a wireless client, such as wireless client 104, may have a single gateway processor, such as Internet gateway processor 122, assigned at boot time regardless of the physical location or network connection of wireless client 104. The wireless client may roam from one access point, such as access point 112, to another access point, such as access point 212, as mentioned before, while still using the same gateway processor, such as Internet gateway processor 122, for redirecting packets to/from the Internet 130.

In accordance with the present invention, virtual central processing device 120 may include a DHCP server 126, a router 128 and more than one Internet gateway processor 122, 124. DHCP server 126 of the present invention may assign local IP addresses to all wireless clients 102, 104, 206, access point 112, and Internet gateway processors 122, 124. Additionally, DHCP server 126 may authenticate wireless clients 102, 104, 206 for security purpose. Additionally, DHCP server 126 may update router 128 with initial routing information to wireless clients 102, 104, 206. Also, DHCP server 126 may initialize wireless clients 102, 104, 206 as mentioned before.

In a situation where two wireless clients are assigned with different Internet gateway processors, such as wireless client 104 assigned with Internet gateway processor 122 and wireless client 206 assigned with Internet gateway processor 124, the Internet gateway processors 122 and 124 may not be able to target the wireless client which does not belong thereto. In accordance with the present invention, DHCP server may know which Internet gateway processor each respective wireless client belongs to and provide such information to the Internet gateway processors 122, 124 so as to facilitate data transfer.

In accordance with the present invention, router 128 may receive routing message from access point 112 and record the routing table; router 128 may update the routing table with the hello messages sent by wireless clients 104. Preferably, router 128 may update the routing table with a periodic message, which aggregates the hello messages by access point 112. Router 128 of the present invention may distribute the routing information to the Internet gateway processors 122, 124 in virtual central processing device 120.

In the case of authentication timeout, i.e. router 128 does not hear from a certain wireless client, such as wireless client 104, for a certain amount of time, router 128 may re-authenticate wireless client 104 to join the network again. Router 128 may remember the respective mapping between wireless client 104 and Internet gateway processor 122. Table 7 shows an example of wireless client information table in Internet gateway processor 122.

TABLE 7
Example Client information table in Internet Gateway Processor

| | | | |
|---|---|---|---|
| Wireless | Wireless Client ID | Access Point | Cost from the |
| Client IP | (smart card ID or | IP address | Access Point to |
| address | MAC address) | | the Wireless Client |

In a preferred embodiment, virtual central processing device 120 may comprise a large group of heavy duty processing machines. Virtual central processing device 120 of the present invention may tunnel all wireless network traffics. The different processing machines can be mapped using different ports on the same virtual central processing device IP address or using different IP addresses. Each Internet gateway processor 122, 124 may process the packets for a fixed number of wireless clients 102, 104, 206. All of the machines in virtual central processing device 120 preferably should have a respective local IP address.

Specifically, the gateway processor, such as Internet gateway processors 122, 124, may be the machine that re-directs the packet for wireless clients, such as wireless client 102, 104 or 206. This processor may also be the default gateway for the mobile wireless clients. For example, Internet gateway processor 122 may be the default gateway for wireless client 104. Since there is more than one Internet gateway processor, such as Internet gateway processors 122, 124, wireless client 104 may have different processor IP address from each other. However, as mentioned above, preferably only one virtual MAC address is used to assist the wireless routing.

In a preferred embodiment, the Internet gateway processors 122, 124 may forward the data packet to the Internet site or wireless clients 102, 104, 206. At Internet gateway processors 122, 124, data packet sending to an Internet site may be de-capsulated before it is sent to the final destination. On the other hand, when a returned response is sent from the Internet site back to the wireless client, such as wireless client 104, the returned response may be encapsulated at Internet gateway processors 122, 124 and then sent to an access point that can best route the returned response to wireless client 104.

In accordance with the present invention, Internet gateway processors 122, 124 may remember the respective mapping between wireless clients 102, 104, 206 and access points 112, 212. Additionally, Internet gateway processors 122, 124 may remember the respective mapping between wireless clients 102, 104, 206 and a special port of the access points 112, 212. This mapping may be based on the last packet received from the wireless clients 102, 104, 206. In other words, the data packet is sent back to where the last one came from. However, a timeout on this mapping may be desirable. If the mapping times out, Internet gateway processors 122, 124 may request a new mapping from router 128.

In accordance with the present invention, Internet gateway processors 122, 124 may also repackage the data packets from the wireless clients 102, 104, 206 to the Internet Site, such as Google. Internet gateway processors 122, 124 of the present invention may use the mesh header added by the wireless client 104 to do re-sequencing/duplicating detection. Table 8 shows an exemplary incoming packet from wireless client 104 in virtual central processing device 120. Table 9 shows an exemplary outgoing packet to the Internet in virtual central processing device 120. Table 10 shows an exemplary incoming packet from the Internet to virtual central processing device 120. Table 11 shows an exemplary outgoing packet to wireless client 104 in virtual central processing device 120.

TABLE 8
Exemplary Incoming packet from wireless client in
virtual central processing device

| | |
|---|---|
| Destination | Virtual Central |
| | Processing Device IP |
| Source | Access Point IP:special port |

Mesh Header

| | |
|---|---|
| Destination | Google:80 |
| Source | 10.0.0.2 |

TABLE 9
Exemplary Outgoing packet to Internet in
virtual central processing device

| Destination | Google:80 |
|---|---|
| Source | 10.0.0.2 |

TABLE 10
Exemplary Incoming packet from Internet in
virtual central processing device

| | |
|---|---|
| Destination | 10.0.0.2 |
| Source | Google:80 |

TABLE 11
Exemplary Outgoing packet to Wireless Client in
virtual central processing device

| | |
|---|---|
| Destination | Access Point IP:special port |
| | Virtual Central Processing |
| Source | Device IP |

Mesh Header

| | |
|---|---|
| Destination | 10.0.0.2 |
| Source | Google:80 |

In one example where a mobile wireless client, such as wireless client 104, is to access an Internet site, such as Google, directly, the additional header is added to the original data packet, indicating the local IP address of the virtual central processing device, such as virtual central processing device 120, as the destination and the local IP address of the wireless client 104, or a device connected thereto, as the source. Then, access point 112 may modify the destination to the global IP address of virtual central processing device 120 and assign a special port to a resolved source address. The destination and source in the original packet remain unchanged. The DSL modem (not shown) may then perform name address translation to resolve the local IP address of the source to an IP address recognizable by a telecom network (not shown). Finally, as the data packet reaches a gateway processor, such as Internet gateway processor 122, the header is stripped off and the tunneling ends. The Internet gateway processor 122 may then forward the original packet to the Internet site, such as Google.

When the Internet site, such as Google, wants to send packets back, the original packet first arrives at the gateway processor, such as Internet gateway processor 122. The Internet gateway processor may add an additional header, indicating the IP address of the DSL modem (not shown) as the destination and the external IP address of the virtual central processing device as the source. DSL modem (not shown) may then perform name address translation to resolve the destination to an address recognizable by the access point, such as access point 112. The DSL modem (not shown) may further assign a special port to the destination. Finally, the data packet arrives at the access point, such as access point 112. The access point 112 may strip off the header and obtain the destination and source addresses indicated in the original packet and forward the data packet to the wireless client accordingly. In accordance with the present invention, the tunneling which starts at Internet gateway processor 122 may now end at access point 112.

Alternatively, the wireless client that sent out the original packet, such as mobile wireless client 104, may have moved to a different zone, such as zone 210, when the Internet site, such as Google, returns a response. In such a case, the Internet gateway processor 122 may obtain new routing information for a proper routing of the data packet from router 128. Consequently, the data packet may be sent to the appropriate access point, such as access point 212. In accordance with the present invention, the tunneling which starts at Internet gateway processor 122 may now end at access point 212. Table 12 shows the network access of a mobile wireless client as mentioned above.

TABLE 12
Exemplary network access for the Stationary Wireless Client
To the Internet site:
10.0.0.4:50 starts the tunneling:

| Dest | Local IP of Virtual Central Processing |
|---|---|
| | Device |
| Src | 10.0.0.4:50 |
| Dest | Google:80 |
| Src | 10.0.0.4:50 |

Access point assigns special port:

| | |
|---|---|
| Dest | Global IP of Virtual Central Processing |
| | Device |
| Src | 192.168.0.2:special port |
| Dest | Google:80 |
| Src | 10.0.0.4:50 |

The DSL will NAT:

| | |
|---|---|
| Dest | Global IP of Virtual Central Processing |
| | Device |
| Src | 166.0.0.55:100 |
| Dest | Google:80 |
| Src | 10.0.0.4:50 |

Internet Gateway Processor strips off the IP
header and ends the tunneling:

| | |
|---|---|
| Dest | Google |
| Src | 10.0.0.4:50 |

From the Internet site:
Internet Gateway Processor starts tunneling:

| | |
|---|---|
| Dest | 166.0.0.55:100 |
| Src | Virtual Central Processing Device ExIP |
| Dest | 10.0.0.4:50 |
| Src | Google:80 |

The DSL will NAT:
Internet Gateway Processor starts tunneling:

| | |
|---|---|
| Dest | 192.168.0.2:special port |
| Src | Virtual Central Processing Device ExIP |
| Dest | 10.0.0.4:50 |
| Src | Google:80 |

The access point ends the tunneling:

| | |
|---|---|
| Dest | 10.0.0.4:50 |
| Src | Google:80 |

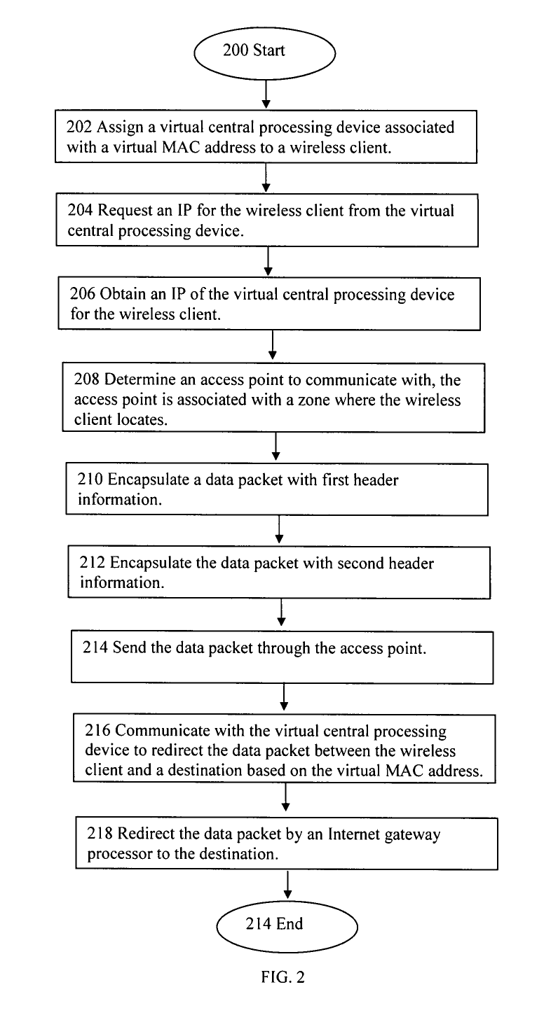

Refer now to FIG. 2, which illustrates a flow chart of a data routing method in accordance with the present invention. The method in accordance with the present invention may utilize a peer-to-peer hopping scheme to cover a large wireless network area where wireless devices, such as wireless client 104, need not remain within a single coverage area. The method of the present invention may support network connectivity for both mobile wireless clients as well as stationary wireless clients. The wireless client of the present invention may be connected to the wired access point directly or through any wireless or wired hopping or routing mechanism. Although the preferred embodiments of the present invention will be described in a wireless peer-to-peer implementation, those skilled in the art should understand that the present invention may also be utilized in any wired and wireless hybrid network so as to allow electronic devices to roam seamlessly between different wired access points wirelessly.

As shown in FIG. 2, the data routing method for routing a data packet in a multi-gateway system in accordance with the present invention begins at step 200. The multi-gateway system, such as peer-to-peer wireless network 100, may include a plurality of wireless clients 102, 104, 206, a plurality of access points 112, 212, and a virtual central processing device 120. At step 202, the wireless client, such as wireless client 104, may be assigned with virtual central processing device 120. The virtual central processing device of the present invention may be one or more devices in one or more physical locations with one or more addresses. The number of virtual central processing devices may increase or decrease based on the loading and complexity of the system. The virtual central processing device 120 of the present invention may be associated with a virtual media access control (MAC) address.

Then, at step 204, wireless client 104 may send a DHCP request to an access point, such as access point 112, to obtain an IP address. At this point, access point 112 may act as a DHCP relay and obtain the IP address for the wireless client 104 from virtual central processing device 120. After the IP address is obtained, wireless client 104 may now communicate directly with virtual central processing device 120 so as to obtain an IP address of the virtual central processing device as if they are in a single virtual network at step 206. In a preferred embodiment, an IP address of the gateway process within virtual central processing device may be obtained; for example, an IP address of Internet gateway processor 122 may be obtained for wireless client 104.

In accordance with the present invention, at step 208, wireless client 104 may now determine an access point to communicate with based on a zone wireless client 104 is in. For example, when wireless client 104 is in zone 110, wireless client 104 may determine to communicate with access point 112. Alternatively, when wireless client 104 is moved to zone 210, wireless client 104 may determine to communicate with access point 212 to forward a data packet. Alternatively, when wireless client 104 is located at a point overlapped by zones 110 and 210, wireless client 104 may simultaneously communicate with both access points 112 and 212.

Additionally, a hopping mechanism may be implemented for the connection between wireless client 104 and access point 112. Or, a wireless routing mechanism may be implemented for the connection between wireless client 104 and access point 112. For example, the wireless client, such as wireless client 104, in zone 110 may first try to maintain a minimum set of close neighbors, namely other wireless clients within the same zone 110 by increasing its transmit power until a predetermined number is met. Once the minimum set of close neighbors is met, wireless client 104 may then determine which neighbor or neighbors are needed to reach access point 112. For example, wireless client 104 in zone 110 may need three hops in order to reach access point 112.

Furthermore, in accordance with the present invention, the method may include an optional step of selectively communicating between a first and second access points based on a respective operating condition of the first and second access points, such as access points 112 and 212. The operating condition of the access points may include but not limited to loading of the hardware, channel condition in the air, number of wireless devices in its vicinity, and distance of each wireless device to the access point.

Then, at step 210, wireless client 104 may encapsulate an original data packet with a first header information, indicating the local IP address of virtual central processing device 120 as the destination and the local IP of wireless client 104 as source such that the original data packet may be sent to the destination through the identified virtual central processing device, such as virtual central processing device 120.

Additionally, at step 212, wireless client 104 may encapsulate the original data packet with a second header, such as a mesh header, in between the 2 TCP headers. This header may provide information to virtual central processing device 120 for packet re-sequencing.

At step 214, the data packet may now be forwarded to the determined access point 112, which is associated with a zone where wireless client 104 currently resides. Then, at step 216, access point 112 may communicate with virtual central processing device 120 to redirect data packet between wireless client 104 and a destination based on the virtual MAC address. In a preferred embodiment, the method of the present invention further includes a step of assigning a special port to access point 112 to redirect the data packet.

In one embodiment where data packet is to be sent to the destination through access point 112, access point 112 may replace the local IP address of virtual central processing device 120 to a global IP address of virtual central processing device 120.

Followed by step 216, virtual central processing device 120 may redirect data packet between wireless client 104 and the destination at step 218. In one embodiment where the data packet is sent from access point to virtual central processing device 120, a gateway processor, such as Internet gateway processor 122, may first de-capsulate the data packet and then forward the data packet to the final destination, such as a web site on the Internet 130. In another embodiment where the data packet is returned from the destination to wireless client 104, Internet gateway processor 122 may first encapsulate the returned response and then forward the returned response to an appropriate access point, which may not be access point 112. Finally, the method of the present invention may end at step 220.

In accordance with the present invention, the method may further include a step of an asymmetric tunneling between wireless client 104 and virtual central processing device 120. In a preferred embodiment, when a data packet is sent by wireless client 104 and received by an Internet site, such as Google, the tunneling may begin at wireless client 104 and ends at virtual central processing device 120. On the other hand, when a data packet is sent by an Internet site, such as Google, and received by wireless client 104, the tunneling may begin at virtual central processing device 120 and end at access point 112. In case where mobile wireless client 104 has moved from one zone to another, such as from zone 110 to zone 210, tunneling may begin at virtual central processing device 120 and end at access point 212, accordingly.

In accordance with the present invention, the method may further include a step of gathering routing information from access point 112. In one embodiment, router 128 may provide a routing table to virtual central processing device 120 by collecting the routing information from access point 112. Furthermore, the method may include a step of sending out hello messages periodically so as to indicate the zone where wireless client 104 belongs and a step of aggregating the hello messages into a periodic message. In one embodiment, the routing table is periodically updated with the periodic message collected from access point 112. As a result, virtual central processing device may utilize such updated routing information to redirect the data packet dynamically on a packet per packet basis. In a preferred embodiment, at least two timing parameters are associated with the hello messages, one timing parameter is related to re-association, while the other is related to loss of IP address.

In accordance with the present invention, the method may further include a step of further including a step of establishing a gradient table to the virtual MAC address so as to establish a connection status for wireless client 104. Generally speaking, a connection status is a status that a wireless client, such as wireless client 104, obtains after it has established a valid route to the virtual central processing device, such as virtual central processing device 120.

In accordance with the present invention, the method may further include a step of assigning a local IP address to devices connected to wireless client 104, thereby communicating with the connected devices through the local IP address.

Although the invention has been described in considerable detail with reference to the preferred version thereof, other versions are within the scope of the present invention. Therefore, the spirit and scope of the appended claims should not be limited to the description of the preferred version contained herein.

What is claimed is:

1. A multi-gateway system, said system comprising:
an access point associated with a zone, said access point providing a network coverage within said zone;
a wireless client adapted to communicate with said access point when said wireless client is in said zone; and
a virtual central processing device associated with a virtual media access control (MAC) address, wherein said virtual central processing device communicates with said access point to redirect a data packet between said wireless client and a destination.

2. The system of claim 1, wherein said access point further comprises a first access point and a second access point, said first and second access points are associated with a first zone and a second zone, respectively, said first zone may overlap said second zone.

3. The system of claim 2, wherein said virtual central processing device comprises a plurality of gateway processors, said plurality of gateway processors forwards said data packet between said wireless client and said destination based on a mapping between said wireless client and one of said first and second access points.

4. The system of claim 3, wherein said plurality of gateway processors is mapped to said virtual MAC address.

5. The system of claim 2, wherein said wireless client is assigned with said virtual processing device such that when said wireless client moves between said first zone and said second zone, said wireless client selectively communicates with said first or second access point, and said same virtual processing device is used to redirect said data packets.

6. The system of claim 2, wherein a respective operating condition of said first and second access points is used to determine which access point said wireless client is to communicate with.

7. The system of claim 1, wherein said data packet is encapsulated with a first header information so as to provide routing information.

8. The system of claim 1, wherein said wireless client encapsulates said data packet with a second additional header so as to provide packet re-sequencing information to said virtual central processing device.

9. The system of claim 1, wherein said virtual central processing device further comprises a router to gather routing information from said access point.

10. The system of claim 9, wherein said wireless client sends out hello messages periodically to indicate said zone said wireless client belongs, thereby updating said gathered routing information.

11. The system of claim 10, wherein at least two timing parameters are associated with said hello messages, one of said at least two timing parameters is related to re-association, the other one of said at least two timing parameters is related to loss of IP address.

12. The system of claim 10, wherein access point further aggregates said hello messages into a periodic message to update said gathered routing information.

13. The system of claim 9, wherein said router provides said gathered information to said virtual central processing device to help said virtual central processing device redirect said data packet dynamically.

14. The system of claim 1, wherein said access point establishes a gradient table to said virtual MAC address so as to establish a connection status of said wireless client.

15. The system of claim 9, wherein said router assigns a cost to said virtual MAC address to said access point.

16. The system of claim 1, wherein said virtual central processing device further comprises a dynamic host configuration protocol (DHCP) server assigning an IP address to said wireless client.

17. The system of claim 1, wherein said wireless client provides a local DHCP function to assign local IP addresses to devices connected thereto.

18. The system of claim 1, wherein said access point assigns a special port thereof to receive said data packet.

19. The system of claim 1, wherein said wireless client connects to said access point through a hopping mechanism.

20. The system of claim 1, wherein said wireless client connects to said access point through a wireless routing mechanism.

21. The system of claim 1, wherein an asymmetric tunneling mechanism is implemented between said wireless client and said virtual central processing device.

22. The system of claim 1, wherein said wireless client increases a transmit power until a minimum set of close neighbors for reaching said access point is obtained.

23. A multi-gateway system, comprising:
an access point associated with a zone, said access point providing a network coverage within said zone;
a wireless client adapted to communicate with said access point when said wireless client is in said zone; and
means for redirecting a data packet between said wireless client and a destination,
wherein said access point communicating with said means for redirecting a data packet between said wireless client and a destinations through a virtual media access control (MAC) address.

24. The system of claim 23, wherein said access point further comprises a first access point and a second access point, said first and second access points are associated with a first zone and a second zone, respectively, said first zone may overlap said second zone.

25. The system of claim 24, wherein said wireless client is assigned with said means for redirecting a data packet between said wireless client and a destination and said virtual MAC address such that when said wireless client moves between said first zone and said second zone, said wireless client selectively communicates with said first or second access point, and said same said means for redirecting a data packet between said wireless client and a destination is used to redirect said data packets.

26. The system of claim 24, wherein a respective operating condition of said first and second access points is used to determine which access point said wireless client is to communicate with.

27. The system of claim 23, wherein said data packet is encapsulated with a first header information so as to provide routing information.

28. The system of claim 23, wherein said wireless client encapsulates said data packet with a second additional header so as to provide packet re-sequencing information to said means for redirecting a data packet between said wireless client and a destination.

29. The system of claim 23, wherein said means for redirecting a data packet between said wireless client and a destination further comprising routing means for gathering routing information from said access point.

30. The system of claim 29, wherein said wireless client sends out hello messages periodically to indicate said zone said wireless client belongs thereby updating said gathered routing information.

31. The system of claim 30, wherein at least two timing parameters are associated with said hello messages, one of said at least two timing parameters is related to re-association, the other one of said at least two timing parameters is related to loss of IP address.

32. The system of claim 31, wherein said access point further aggregates said hello messages into a periodic message to update said gathered routing information.

33. The system of claim 29, wherein said routing means provides said gathered routing information to said means for redirecting a data packet between said wireless client and a destination to help said means for redirecting a data packet between said wireless client and a destination redirect said data packet dynamically.

34. The system of claim 23, wherein said access point establishes a gradient table to said virtual MAC so as to establish a connection status of said wireless client.

35. The system of claim 29, wherein routing means assigns a cost to said virtual MAC address to said access point.

36. The system of claim 23, wherein said means for redirecting a data packet between said wireless client and a destination further comprises means for assigning an IP address to said wireless client.

37. The system of claim 23, wherein said wireless client provides a local dynamic host configuration protocol (DHCP) function to assign local IP addresses to devices connected thereto.

38. The system of claim 23, wherein said access point assigns a special port thereof to receive said data packet.

39. The system of claim 23, wherein said wireless client connects to said access point through a hopping mechanism.

40. The system of claim 23, wherein said wireless client connects to said access point through a wireless routing mechanism.

41. The system of claim 23, wherein an asymmetric tunneling mechanism is implemented between said wireless client and said means for redirecting a data packet between said wireless client and a destination.

42. The system of claim 24, wherein said means for redirecting a data packet between said wireless client and a destination further comprising a plurality of processing means, said plurality of processing means forwarding said data packet between said wireless client and said destination based on a mapping between said wireless client and one of said first and second access points.

43. The system of claim 23, wherein said wireless client increases a transmit power until a minimum set of close neighbors for reaching said access point is obtained.

44. A data routing method adapted in a multi-gateway system, said multi-gateway system comprising a wireless client, an access point and a virtual central processing device said access point associated with a zone, said method comprising at least the following steps:
assigning said virtual central processing device to said wireless client, said virtual central processing device associated with a virtual media access control (MAC) address;
identifying said access point to communicate with, said access point associated with a zone said wireless client is in; and
communicating with said virtual central processing device by said access point to redirect a data packet between said wireless client and a destination.

45. The method of claim 44, wherein said access point further comprises a first access point and a second access point, said first and second access points are associated with a first zone and a second zone, respectively, said first zone may overlap said second zone.

46. The method of claim 45, further comprising forwarding said data packet between said wireless client and said destination based on a mapping between said wireless client and one of said first and second access points.

47. The method of claim 45, further comprising selectively communicating between said first and second access points based on a respective operating condition of said first and second access point.

48. The method of claim 44, further comprising encapsulating said data packet with a first header information so as to provide routing information.

49. The method of claim 44, further comprising encapsulating said data packet with a second additional header so as to provide packet re-sequencing information to said virtual central processing device.

50. The method of claim 44, further comprising gathering routing information from said access point.

51. The method of claim 50, further comprising sending out hello messages periodically so as to indicate said zone said wireless client belongs, thereby updating said gathered routing information.

52. The method of claim 50, wherein at least two timing parameters are associated with said hello messages, one of said at least two timing parameters is related to re-association, the other one of said at least two timing parameters is related to loss of IP address.

53. The method of claim 51, further comprising aggregating said hello messages into a periodic message to update said gathered routing information.

54. The method of claim 50, further comprising providing said gathered information to said virtual central processing device to help redirect said data packet dynamically.

55. The method of claim 44, further comprising establishing a gradient table to said virtual MAC address so as to establish a connection status of said wireless client.

56. The method of claim 44, further comprising assigning a cost to said virtual MAC address to said access point.

57. The method of claim 44, further comprising assigning an IP address to said wireless client.

58. The method of claim 44, further comprising assigning a local IP address to devices connected to said wireless client.

59. The method of claim 44, further comprising assigning a special port to said access point to receive said data packet.

60. The method of claim 44, further comprising utilizing a hopping mechanism to connect said wireless client and said access point.

61. The method of claim 44, further comprising utilizing a hopping mechanism to connect said wireless client and said access point.

62. The method of claim 44, further comprising implementing an asymmetric tunneling between said wireless client and said virtual central processing device.

63. The system of claim 44, further comprising increases a transmit power of said wireless client until a minimum set of close neighbors for reaching said access point is obtained.

64. An electronic device, comprising:
a wireless client adapted to communicate with an access point when said electronic device is in a zone associated with said access point, wherein said wireless client is assigned with a virtual central processing device associated with a virtual media access control (MAC) access such that said virtual central processing device communicates with said access point to redirect a data packet between said wireless client and a destination.

65. The electronic device of claim 64, wherein said access point comprises a first access point and a second access point such that when said wireless client moves between said first zone and said second zone, said wireless client selectively communicates with said first or second access point, and said same virtual processing device is used to redirect said data packets.

66. The electronic device of claim 65, wherein a respective operating condition of said first and second access points is used to determine which access point said wireless client is to communicate with.

67. The electronic device of claim 64, wherein said wireless client encapsulates said data packet with a first header information so as to provide routing information.

68. The electronic device of claim 64, wherein said wireless client encapsulates said data packet with a second header information so as to provide packet re-sequencing information to said virtual central processing device.

69. The electronic device of claim 64, wherein said wireless clients sends out hello messages periodically to indicate said zone said wireless client belongs, thereby updating a gathered routing information.

70. The electronic device of claim 69, wherein at least two timing parameters are associated with said hello messages, one of said at least two timing parameters is related to re-association, the other one of said at least two timing parameters is related to loss of IP address.

71. The electronic device of claim 64, wherein said wireless client provides a local DHCP function to assign local IP addresses to devices connected to said electronic device.

72. The electronic device of claim 64, wherein said wireless client connects to said access point through a hopping mechanism.

73. The electronic device of claim 64, wherein said wireless client connects to said access point through a wireless routing mechanism.

74. The electronic device of claim 64, wherein an asymmetric tunneling mechanism is implemented between said wireless client and said virtual central processing device.

75. The electronic device of claim 64, wherein said wireless client increases a transmit power until a minimum set of close neighbors for reaching said access point is obtained.
